(19) United States
(12) Patent Application Publication
(10) Pub. No.: US 2024/0308380 A1
(43) Pub. Date: Sep. 19, 2024

(54) CHARGING SYSTEM

(71) Applicant: TOYOTA JIDOSHA KABUSHIKI KAISHA, Toyota-shi (JP)

(72) Inventor: Daiki TAKAYAMA, Toyota-shi (JP)

(73) Assignee: TOYOTA JIDOSHA KABUSHIKI KAISHA, Toyota-shi (JP)

(21) Appl. No.: 18/521,604

(22) Filed: Nov. 28, 2023

(30) Foreign Application Priority Data
Mar. 16, 2023 (JP) 2023-041714

(51) Int. Cl. B60L 53/66; B60L 53/18; B60L 53/62; H02J 7/00

(52) U.S. Cl. CPC B60L 53/66; B60L 53/18; B60L 53/62; H02J 7/007182; H02J 2207/20; H02J 2310/48

(57) ABSTRACT

The automobile controller notifies the controller of the power feed device (power supply controller) of the charging voltage prior to charging the battery. After receiving the charging voltage, the power feed controller raises the voltage at the output end of the power supply device to the supply voltage that is lower than its own rated output voltage and the charging voltage. The automobile controller monitors the voltage at the output end to identify the supply voltage while the power feed controller performs a ground fault check. The automobile controller (1) charges the battery with electric power of the supply voltage if the supply voltage is equal to the charge voltage, and (2) drives a boost converter to reduce the supply voltage to the charge voltage if the supply voltage is lower than the charge voltage, and then charge the battery with electric power from the power feed device.

### CROSS-REFERENCE TO RELATED APPLICATION

This application claims priority to Japanese Patent Application No. 2023-041714 filed on Mar. 16, 2023, incorporated herein by reference in its entirety.

### BACKGROUND

### 1. Technical Field

The technology disclosed in this specification relates to a charging system including an automobile having a battery, and a power feed device for charging the battery. Battery vehicles are included.

### 2. Description of Related Art

Battery electric vehicles equipped with batteries are rapidly becoming commonplace. As battery electric vehicles become widespread, it is expected that power feed devices (charging stations) will also become widespread. In the future, in a plurality of battery electric vehicles connected to power feeding devices, there is a possibility that rated voltages of batteries installed in the battery electric vehicles will be different from each other. There is also a possibility that old type power feed devices will have a low power feed voltage, and new type power feed devices will have a high power supply voltage. Information needs to be exchanged between power feed devices and battery electric vehicles prior to charging, in order to match output voltage of the power feed devices to voltage that is acceptable to the battery electric vehicles receiving electric power. In general, adjusting variables for data communication (or variables related to electric power that is transmitted) prior to data communication (or transmission/reception of electric power) is called a handshake. A handshake is also performed between a power feed device and an automobile prior to charging (for example, Japanese Unexamined Patent Application Publication No. 2019-47677 (JP 2019-47677 A)).

### SUMMARY

In a battery electric vehicle, when voltage (supply voltage) of electric power obtained from a power feed device is equal to a voltage suitable for charging a battery (charging voltage), the electric power sent from the power feed device can be directly sent to the battery. When the supply voltage is lower than the charging voltage, the battery electric vehicle must boost the voltage of the electric power sent from the power feed device before charging the battery. The battery electric vehicle needs to know the supply voltage of the power feed device prior to charging. The battery electric vehicle learns the power feed voltage through the handshake described above. The present specification provides technology for simplifying a handshake protocol between the battery electric vehicle and the power feed device prior to charging.

The present specification discloses a charging system including an automobile including a battery, and a power feed device for charging the battery.

The automobile notifies the power feed device of a voltage suitable for charging the battery (charging voltage), prior to charging the battery.

The power feed device, upon receiving the charging voltage, raises voltage at an output end (electric power output end) of the power feed device to a lower supply voltage of a rated output voltage of itself (greatest output voltage), and the charging voltage, and concurrently executes a leakage check of checking for presence or absence of leakage between a positive electrode and a negative electrode of the output end.

Such a leakage check is stipulated, for example, in the international standard (GB/T18487), relating to battery charging of battery electric vehicles, and so forth.

The power feed device starts power feed to the battery at the supply voltage when no leakage is detected by the leakage check.

The automobile monitors the voltage at the output end while the power feed device is executing the leakage check, to identify the supply voltage.

(1) The automobile charges the battery with electric power at the supply voltage when the supply voltage is equal to the charging voltage.

Alternatively, (2) the automobile raises the supply voltage to the charging voltage using a boost converter when the supply voltage is lower than the charging voltage, and charges the battery with electric power from the power feed device.

According to the technology disclosed in the present specification, the automobile monitors output end voltage of the power feed device when the power feed device performs the leakage check, and identifies the supply voltage. According to the technology disclosed in the present specification, the protocol in the handshake for the power feed device to notify the automobile of the supply voltage can be omitted.

Details of the technology disclosed in the present specification, and further modifications, will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of an example charging system; and

FIG. 2 is a flow diagram of the charging process performed by the automobile and the power feed device (including the handshake protocol between the vehicle and the power feed device).

### DETAILED DESCRIPTION OF EMBODIMENTS

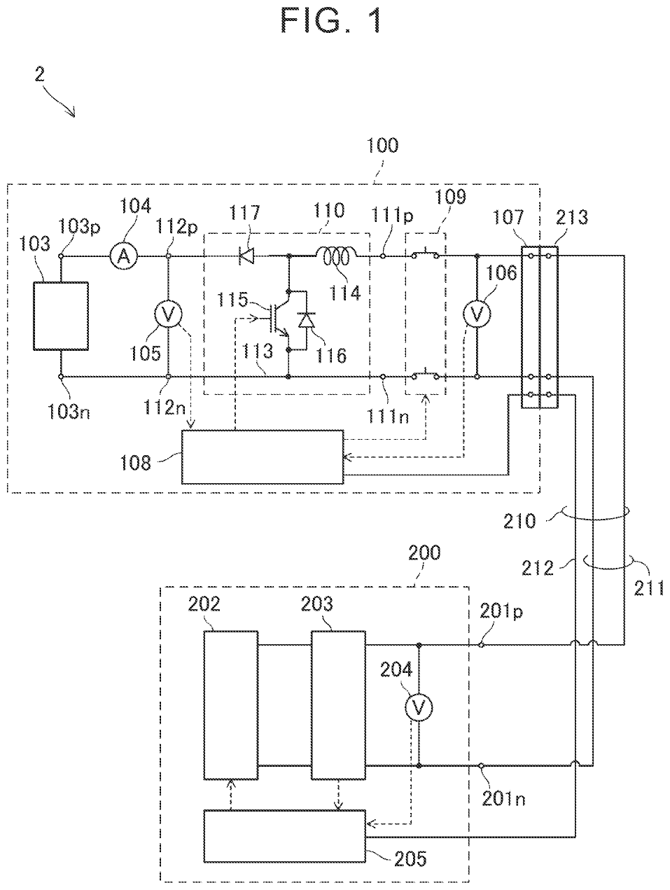

A charging system 2 of an embodiment will be described with reference to the drawings. FIG. 1 shows a block diagram of the charging system 2. A charging system 2 of the embodiment includes a battery electric vehicle 100 and a power feed device 200.

The battery electric vehicle 100 has a driving motor (not shown). Battery electric vehicle 100 includes battery 103, boost converter 110, charging relay 109, charging inlet 107, voltage sensors 105 and 106 and controller 108.

Battery 103 sends electric power to an inverter (not shown). The inverter converts the DC electric power of the battery 103 into drive power for the drive motor and sends it to the drive motor. The controller 108 determines the target output of the inverter (running motor) from the vehicle speed and accelerator operation amount, and controls the inverter so as to achieve the target output.

The battery 103 can be charged with electric power supplied from an external power feed device 200. A boost converter 110 is connected between the battery 103 and the charging inlet 107. Boost converter 110 includes reactor 114, switching element 115, and diodes 116 and 117. One end of the reactor 114 is connected to the input end positive electrode 111p and the other end is connected to the high potential side of the switching element 115. A low potential side of the switching element 115 is connected to the ground line 113. A ground line 113 connects the input end negative electrode 111n and the output end negative electrode 112n. A diode 116 is connected in antiparallel to the switching element 115.

A diode 117 is connected between the other end of the reactor 114 and the output end positive electrode 112p. The diode 117 allows current to flow from the input end positive electrode 111p to the output end positive electrode 112p and blocks current flow in the opposite direction. In other words, diode 117 is provided to prevent backflow of current.

Switching element 115 is controlled by controller 108. When the controller 108 appropriately turns on and off the switching element 115, the voltage input to the input terminal 111 is boosted and output from the output end 112. A voltage sensor 106 is connected between the input end positive electrode 111p and the input end negative electrode 111n. A voltage sensor 105 is also connected between the output end positive electrode 112p and the output end negative electrode 112n. The measured values of voltage sensors 105 and 106 are sent to controller 108. The controller 108 drives the switching element 115 so that the ratio of the measured values of the voltage sensors 105 and 106 (that is, the ratio of the voltage at the output end 112 to the voltage at the input terminal 111) becomes the target step-up ratio.

A charging relay 109 is connected between the boost converter 110 and the charging inlet 107. The charging relay 109 is also controlled by the controller 108.

The power feed device 200 includes a DC power supply 202, an earth leakage detector 203, a voltage sensor 204 and a controller 205. Controller 205 controls DC power supply 202. The leakage detector 203 checks whether or not leakage occurs between the output end positive electrode 201p and the output end negative electrode 201n of the power feed device 200. The positive output end 201 p and the negative output end 201 n are electric power output ends for outputting power for charging the battery 103. Hereinafter, the output end positive electrode 201p and the output end negative electrode 201n may be collectively referred to as the output end 201.

The result of the leakage check is notified to the controller 205. When the earth leakage detector 203 detects the earth leakage, the controller 205 immediately stops the DC power supply 202. Controller 205 also monitors the voltage at output end 201 by voltage sensor 204. The controller 205 monitors the measured value of the voltage sensor 204 to check whether the DC power supply 202 is outputting the desired voltage.

Power feed device 200 and battery electric vehicle 100 are connected by charging cable 210. A connector 213 at the tip of charging cable 210 is connected to charging inlet 107. Charging cable 210 includes electric power cable 211 that transmits electric power and communication cable 212. An electric power cable 211 transmits electric power from the power feed device 200 (DC power supply 202) to the battery electric vehicle 100 (battery 103).

A communication cable 212 connects the controller 108 of the battery electric vehicle 100 and the controller 205 of the power feed device 200. Communication cable 212 allows controller 108 of battery electric vehicle 100 and controller 205 of power feed device 200 to exchange information.

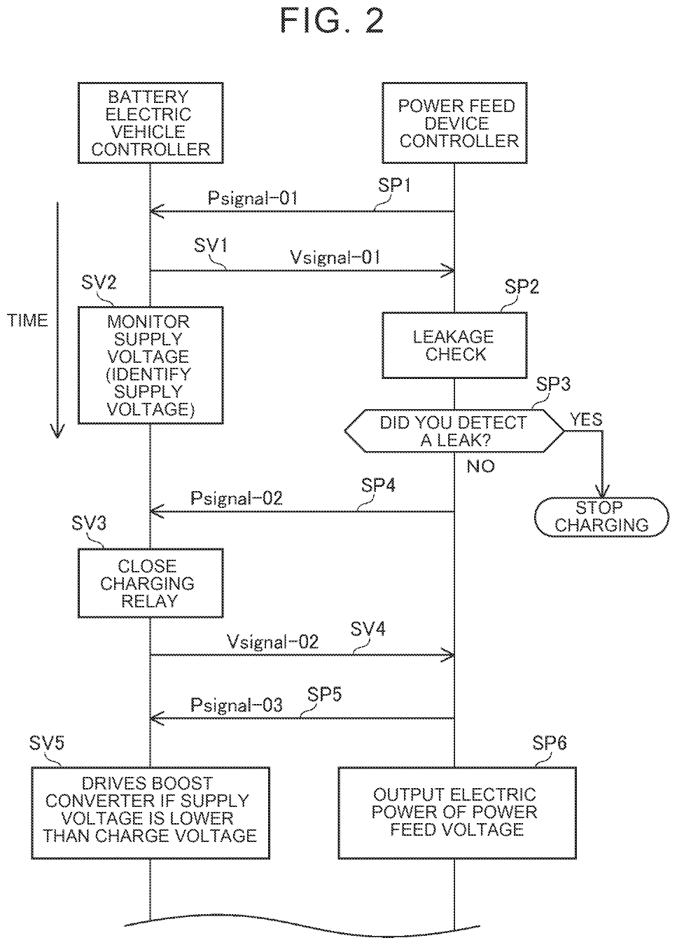

Battery electric vehicle 100 and power feed device 200 charge battery 103 while exchanging data via communication cable 212. FIG. 2 shows a flow diagram of the charging process performed by controller 108 of battery electric vehicle 100 and controller 205 of power feed device 200. Also depicted in FIG. 2 is the handshake protocol exchanged between controller 108 of battery electric vehicle 100 and controller 205 of power feed device 200. In FIG. 2, “SPx” (where “x” is a number) denotes processing performed by the controller 205 of the power feed device 200, and “SVx” (where “x” is a number) denotes processing performed by the controller 108 of the battery electric vehicle 100. In FIG. 2. “Psignal-0x” (“x” is a number) means a signal (data) sent from the controller 205 to the controller 108, and “Vsignal-0x” (“x” is a number) is a signal (data) that the controller 108 sends to the controller 205.

For convenience of explanation, a voltage suitable for charging the battery 103 is called a charging voltage, and a voltage of electric power provided by the power feed device 200 is called a supply voltage.

Controller 108 of battery electric vehicle 100 does not activate boost converter 110 when the supply voltage is equal to the charging voltage. Input terminal positive terminal 111 p and output end positive terminal 112 p of boost converter 110 are connected via reactor 114 and diode 117. If the switching element 115 is stopped, the reactor 114 and the diode 117 flow the electric power input to the input end positive electrode 111p as it is to the output end positive electrode 112p. That is, the electric power of the supply voltage is sent to the battery 103 as it is. The controller 108 charges the battery 103 with the electric power of the supply voltage when the supply voltage is equal to the charge voltage.

When the supply voltage is lower than the charging voltage, controller 108 drives boost converter 110 (switching element 115) to boost the supply voltage to the charging voltage and charge battery 103.

Controller 108 of battery electric vehicle 100 does not know the supply voltage provided by power feed device 200 before power feed device 200 is connected to charging inlet 107. Prior to charging, controller 108 needs to know the supply voltage. On the other hand, controller 205 of electric power feed device 200 needs to know the voltage acceptable to battery electric vehicle 100 prior to supplying power. The processing of FIG. 2 includes a protocol for the controllers 108, 205 to input and output necessary information to each other.

The processing in FIG. 2 is started when power feed device 200 is connected to charging inlet 107. First, the controller 205 of the power feed device 200 sends a signal Psignal-01 to the controller 108 of the battery electric vehicle 100 (SP1). The signal Psignal-01 is a handshake message from controller 205 to controller 108 and includes the protocol version of power feed device 200.

Upon receiving signal Psignal-01, controller 108 sends signal Vsignal-01 to controller 205 (SV1). A signal Vsignal-01 is a handshake message from the controller 108 to the controller 205 and contains information on a voltage suitable for charging the battery 103 (charging voltage). That is, the controller 108 notifies the charging voltage to the controller 205 prior to charging the battery 103.

Upon receiving the signal Vsignal-01, the controller 205 checks for electric leakage (SP2). The power feed device 200 performs an electric leakage check in the following procedure. The controller 205 raises the voltage of the output end 201 to the lower voltage (supply voltage) of its own rated output voltage and the charging voltage, and checks whether or not an electric leakage occurs between the output end positive electrode 201p and the output end negative electrode 201n. The rated output voltage of the power feed device 200 is equal to the maximum output voltage that the power feed device 200 can output.

As described above, the leakage detector 203 is connected between the output end positive electrode 201p and the output end negative electrode 201n. Leakage detector 203 checks the difference between the current flowing from output end positive electrode 201p and the current returning to output end negative electrode 201n, and determines that an electric leak has occurred if the current difference exceeds a predetermined allowable value.

If the electric leakage is detected, the controller 205 stops the charging process (SP3: YES). If no electric leakage is detected, controller 205 sends signal Psignal-02 to controller 108 (SP4). Signal Psignal-02 contains a message indicating that charging can be started.

Upon receiving the signal Psignal-02, the controller 108 closes the charging relay 109 (SV3) when the battery electric vehicle side is ready for charging, and sends the signal Vsignal-02 to the controller 205 (SV4). The signal Vsignal-02 contains a message indicating that the battery electric vehicle has finished preparations for charging.

The controller 205 that has received the signal Vsignal-02 sends Psignal-03 including a message to start electric power output to the controller 108 (SP5). Subsequently, the controller 205 starts outputting electric power of the supply voltage (SP6).

Upon receiving signal Psignal-03, controller 108 drives boost converter 110 if the supply voltage is lower than the charging voltage (SV5). The controller 108 has already identified the supply voltage in the process of SV2. The target boost ratio of boost converter 110 is determined by “charging voltage/supply voltage”. Controller 108 drives switching element 115 so that the target voltage ratio is achieved.

If the supply voltage is equal to the charging voltage, controller 108 will not activate boost converter 110. The charging inlet 107 (power feed device 200) and the battery 103 are directly connected, and the electric power of the supply voltage is sent to the battery 103. That is, battery 103 is charged.

After that, the power feed device 200 continues to output the electric power of the supply voltage until the battery 103 reaches full charge. Since the processing after the battery 103 reaches full charge is the same as the conventional charging processing, the description is omitted.

As described above, in the processing of FIG. 2, the controller 205 of the power feed device 200 does not explicitly notify the controller 108 of the battery electric vehicle 100 of the supply voltage. Controller 108 can identify the supply voltage by monitoring the voltage at output end 201 during the leakage check performed by controller 205. Pre-charging communication is simplified because no communication from controller 205 to controller 108 to explicitly inform the supply voltage is required.

The processing of the controller 108 and the controller 205 during charging is summarized as follows. The controller 108 of the battery electric vehicle 100 notifies the controller 205 of the power feed device 200 of the charging voltage prior to charging the battery 103. The controller 205 that has received the charging voltage increases the voltage of the output end 201 to the supply voltage of the lower one of its own rated output voltage and the charging voltage, and checks whether there is a leakage between the output end positive electrode 201p and the output end negative electrode 201n. The controller 205 starts power feed to the battery 103 at the supply voltage if no leakage is detected by the leakage check. Controller 108 monitors the voltage at output end 201 to identify the supply voltage while controller 205 performs a ground fault check. The controller 108 then (1) charges the battery 103 with electric power at the supply voltage if the supply voltage is equal to the charge voltage. Alternatively, the controller 108 (2) drives the boost converter 110 to increase the supply voltage to the charging voltage when the supply voltage is lower than the charging voltage, and then charges the battery 103 with the electric power of the power feed device 200.

The detailed procedure of the leakage check and the handshake protocol exchanged between the controller 108 and the controller 205 are defined in the international standard (GB/T18487) for battery charging of battery electric vehicles for reference.

To distinguish between controller 108 of battery electric vehicle 100 and controller 205 of power feed device 200, controller 108 may be referred to as an automobile controller and controller 205 may be referred to as a power feed controller.

Although the specific examples have been described in detail above, these are merely examples and do not limit the scope of claims. The techniques described in the claims include various modifications and alternations of the specific example illustrated above. The technical elements described in the present specification or the drawings exhibit technical usefulness alone or in various combinations, and are not limited to the combinations described in the claims at the time of filing. In addition, the techniques illustrated in the present specification or drawings can achieve a plurality of objectives at the same time, and achieving one of the objectives itself has technical usefulness.

What is claimed is:

1. A charging system including an automobile including a battery, and a power feed device for charging the battery, wherein:
the automobile notifies the power feed device of a charging voltage suitable for charging the battery, prior to charging the battery;
the power feed device, upon receiving the charging voltage, raises voltage at an output end of the power feed device to a lower supply voltage of a rated output voltage of itself, and the charging voltage, and concurrently executes a leakage check of checking for presence or absence of leakage between a positive electrode and a negative electrode of the output end, and starts power feed to the battery at the supply voltage when no leakage is detected by the leakage check; and
the automobile monitors the voltage at the output end while the power feed device is executing the leakage check, to identify the supply voltage, and
(1) charges the battery with electric power at the supply voltage when the supply voltage is equal to the charging voltage, and
(2) raises the supply voltage to the charging voltage using a boost converter when the supply voltage is lower than the charging voltage, and charges the battery with electric power from the power feed device.
